(19) United States
(12) Patent Application Publication
(10) Pub. No.: US 2007/0131117 A1
(43) Pub. Date: Jun. 14, 2007

(54) Apparatus for cooking pasta by steeping

(76) Inventor: Matthew Rittberg, Parsippany, NJ (US)

Correspondence Address: LADAS & PARRY LLP, 224 SOUTH MICHIGAN AVENUE, SUITE 1600, CHICAGO, IL, 60604, US

(21) Appl. No.: 11/297,996

(22) Filed: Dec. 8, 2005

(51) Int. Cl. A23L 1/00

(52) U.S. Cl. 99/275

(57) ABSTRACT

Pastas and other foods are cooked by being steeped in a small volume of water added to an insulated vessel provided with a removable cover and strainer. The preferred embodiment of the cooking vessel is an insulated cylinder of translucent plastic. The cylinder walls and base are insulated. An open top enables water and a food item to be introduced into the vessel's interior volume. A removable cover for the open top retains heat. A removable strainer for the open top allows water to be drained off. Food items cook in the vessel without additional heat being added to the water during the cooking process.

### BACKGROUND ART

Prior art devices for cooking spaghetti and other pastas abound. All of them use water, of course, but they also require a source of thermal energy by which the pasta-cooking water is heated to, or near, the water's boiling point. As is well known, boiling water softens pasta so that it in a relatively short time it becomes edible.

A problem with prior art pasta cooking devices is that you have to boil a large volume of water to cook a relatively small amount of pasta. When the pasta has been cooked, a lot of the water that was initially drawn to cook the pasta is drained off. The time and energy needed to boil water that wasn't needed to cook the pasta are wasted.

Another problem with prior art pasta cookers that use a thermal energy source to boil water to cook pasta, is the real possibility that the water in the cooking vessel can evaporate completely if the cooker is not monitored. If the cooking water boils away completely, the pasta will be ruined but a fire risk also arises.

Another problem with prior art pasta cooking devices is the need to closely monitor pasta cooking time. As is well known, pasta that is cooked substantially longer than 11-15 minutes quickly becomes unpalatable. An apparatus for cooking pasta without needing externally supplied thermal energy would be an improvement over the prior art.

### SUMMARY OF THE INVENTION

There is provided an apparatus for cooking pasta by steeping the pasta (i.e., by the pasta's immersion in heated water that. is added to a thermally insulated vessel and without requiring or using thermal energy added to the water from another source). Pasta or other food items can be safely and conveniently cooked using a very small amount of boiled water, without having to supply extra energy to the water, by allowing the pasta or other food items to soak in the hot water that is added to a thermally insulated vessel.

In the preferred embodiment, the thermally insulated vessel is a translucent cylinder, the walls and bottom of which are insulated to reduce heat transfer from the cooking water in the vessel. The open top of the cylinder is sized, shaped and arranged to accept a snap-on strainer and a cover that fits over the strainer. Once cooking is completed, cooking water in the vessel is disposed of by removing the cover to expose the snap-on strainer. Cooking water is drained and cooked food in the vessel retained by simply pouring the cooking water out of the vessel through the snap-on strainer. By snapping the strainer off of the cylinder, the cooked food items can be served directly into a serving dish or plate.

### BRIEF DESCRIPTION OF THE DRAWINGS

FIG. 1 is a perspective view of the preferred embodiment of the apparatus for cooking pasta by steeping;

FIG. 2 is a perspective view of the apparatus as shown in FIG. 1 but with its snap-on strainer and cover removed;

FIG. 3 is an exploded view of the apparatus shown in FIG. 1, including the strainer and cover;

FIG. 4 is a side view of the apparatus for cooking pasta by steeping, shown with spaghetti in the vessel and without the strainer and cover;

FIG. 5 shows how the apparatus for cooking pasta by steeping can be used;

FIG. 6 shows the apparatus should be filled with water to cook pasta by steeping, including the snap-on strainer;

FIG. 6A shows the apparatus with the snap-on strainer in place and the placement of the cover over the strainer;

FIG. 7 shows the use of the snap-on strainer to dispose of cooking water;

FIG. 8 shows the removal of the snap-on strainer to allow cooked pasta to be served; and

FIG. 9 shows the structure of the insulated side walls of the vessel.

### DETAILED DESCRIPTION OF THE PREFERRED EMBODIMENT

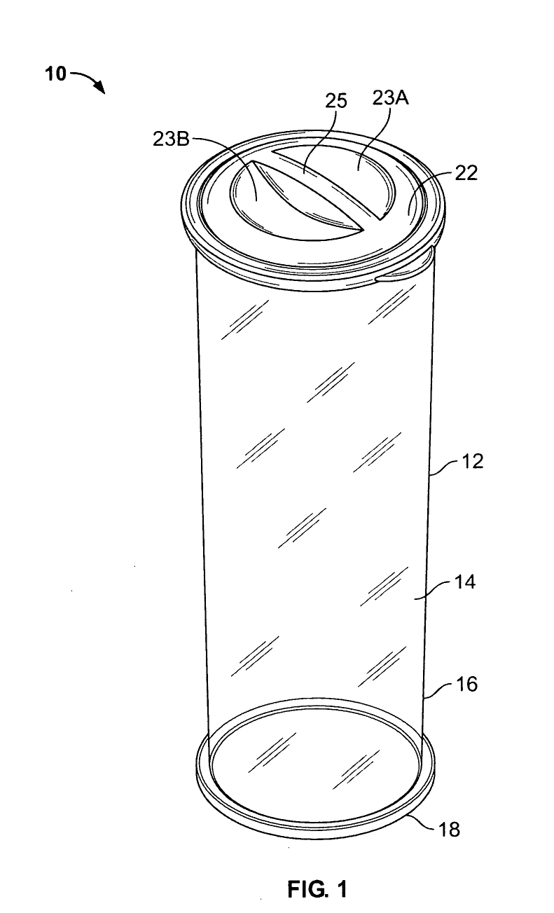

FIG. 1 shows a perspective view of the preferred embodiment of an apparatus 10 for cooking pasta by steeping. The preferred embodiment of the apparatus 10 is a cylinder shaped vessel 12 with an interior volume 14 defined by an insulated side wall 16 and an insulated bottom 18.

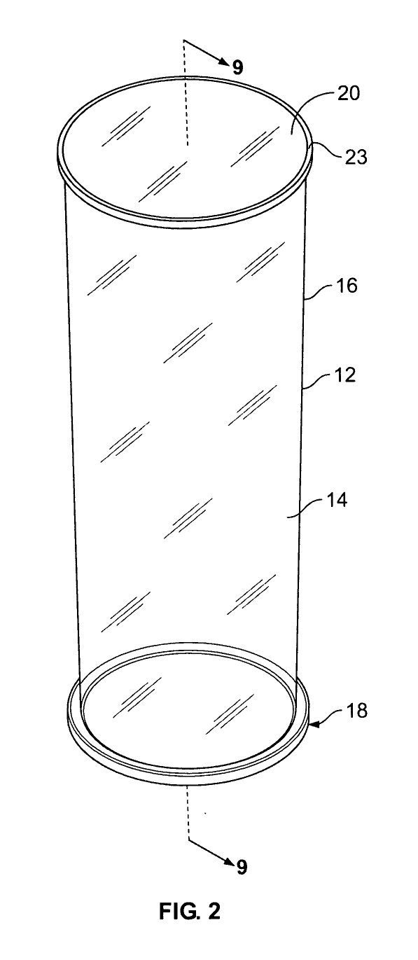

As shown in FIG. 2, the top 20 of the cylinder-shaped vessel 12 is open. The open top 20 allows water and pasta or other food items to be introduced (added, inserted or placed) into the vessel's interior 14. Since the top 12 is open, the interior volume 14 is not pressurized and will not build up any pressure, even if additional thermal energy were to be added to water or food items in the vessel.

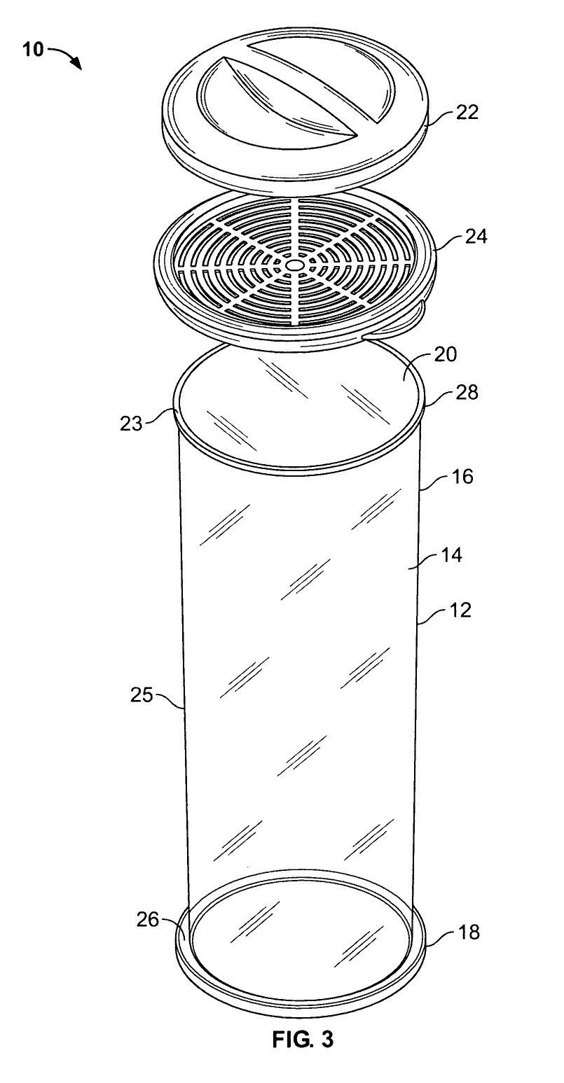

FIG. 3 is an exploded view of the apparatus shown in FIG. 1 and more clearly shows a snap-on strainer 24 for the vessel 12 and a cover 22 that snuggly fits over the strainer 24. As shown in FIG. 3, an annular lip or ridge 23 is sized, shaped and arranged on the extreme upper edge of the cylinder shaped vessel 12 to have an outside diameter just slightly larger than a mating groove formed into the inside diameter of the strainer 24. Since both the vessel 12 and the strainer 24 are formed of plastic, they are both deformable by moderate force, which allows the groove of the strainer 24 to engage the lip/ridge 23 to hold the strainer 24 in place over the top 20 of the vessel 12.

A flexible plastic cover 22 is sized, shaped and arranged to fit over the strainer 24 in order to close off the top 20 of the vessel 12 and thereby retain heat in the interior 14 of the vessel 12. As shown in FIG. 1, two valleys or depressions 23A and 23B are formed into the cover 22 to define a center ridge 25 that can be easily grasped by a user's thumb and index fingers by which the cover 22 can be lifted off away from the strainer 24.

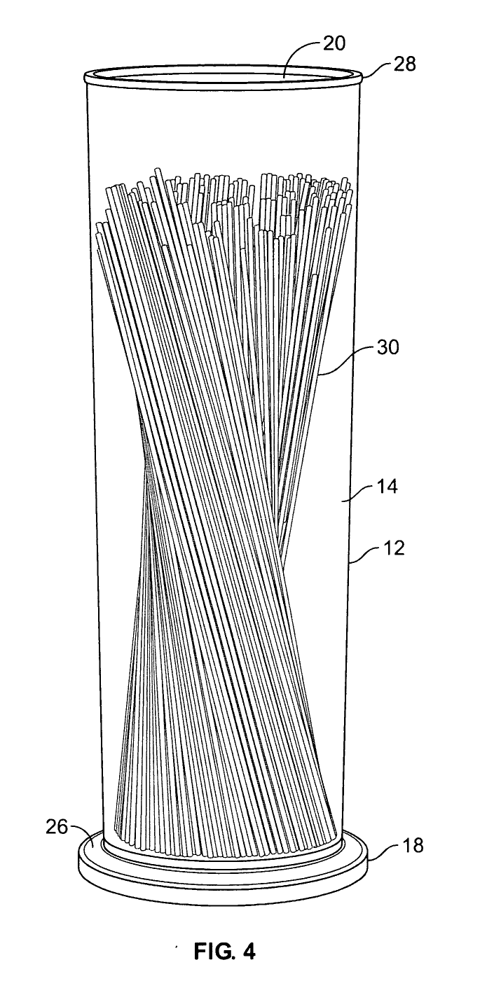

Turning now to FIG. 4 there is shown a side view of the apparatus for cooking pasta by steeping 10, including a quantity of spaghetti or other pasta 30 placed into the interior volume 14 of the vessel that is defined by the side wall 12 and the insulated bottom 18. In FIG. 4, however, both the strainer and the top are removed in order to show how pasta 30 or other food items can be introduced into the interior volume 14.

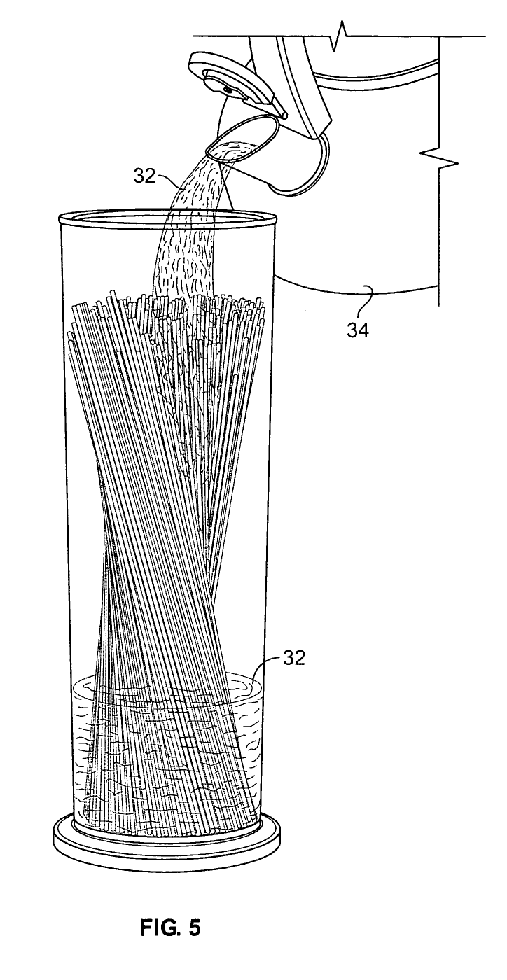

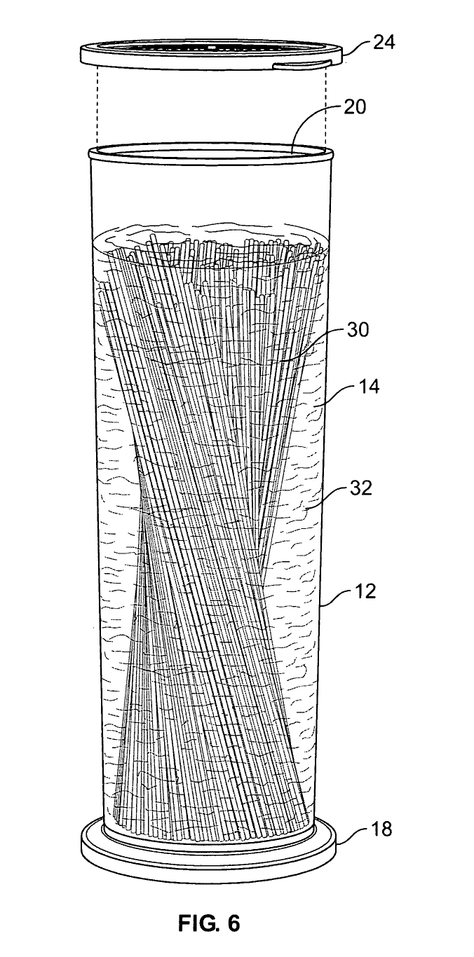

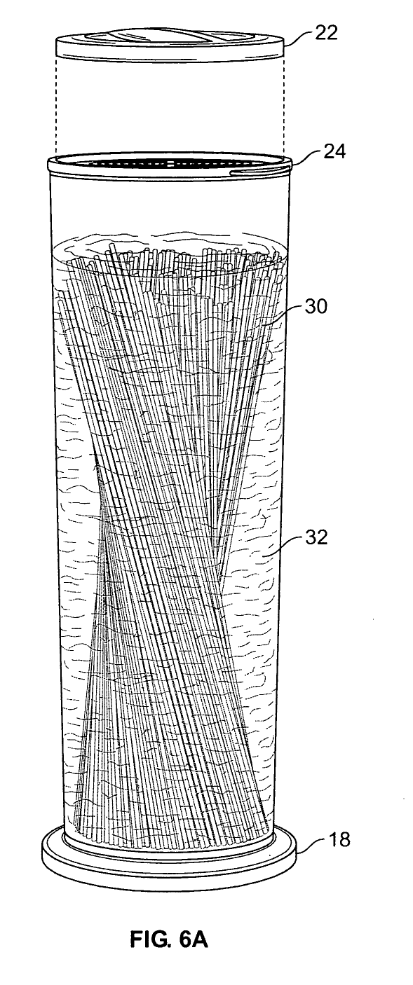

As shown in FIG. 5, hot water 32 can be poured from a kettle 34, directly into the vessel 12 and over the pasta 30. As shown in FIG. 6, once the vessel 12 is filled with enough hot water 32 to completely cover the pasta 30, the strainer 24 is placed over the open top 20. As shown in FIG. 6A, the cover 22 is then placed over the strainer 24, which helps to retain heat within the vessel 12 and improve cooking of the pasta 30.

Depending on the initial temperature and volume of the water 32 added to the vessel, and depending on the initial temperature and mass of the pasta 30 in the vessel, the pasta 30 in the vessel will of course absorb water 32 and over time it will soften to the point where it is considered cooked. The food is heated by the transfer of heat energy from the confined water to the food. Vessel 12 may also be used to cook and otherwise prepare other foods that may require contact with or immersion into hot water for cooking, such as vegetables and sea food. Thus, pasta 30 in the vessel is cooked by being steeped.

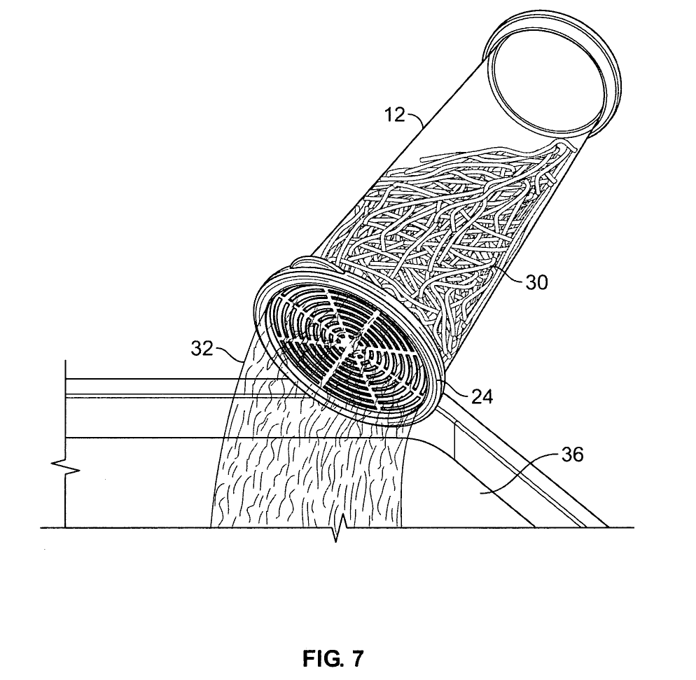

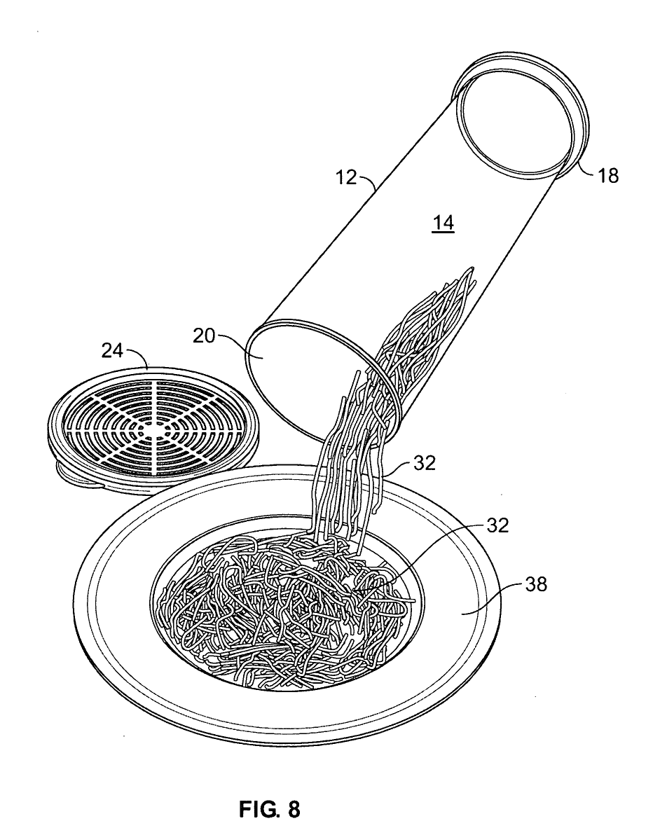

As shown in FIG. 7, cooked pasta 30 and the cooking water 32 are separated from each other by removing the cover (not shown in FIG. 7) and pouring the water 32 from the vessel 12 into a sink 36 or other container. Thereafter, as shown in FIG. 8, the cooked pasta 30 is served from the vessel 12, directly onto a plate or other serving dish by simply removing the strainer 24 from the top 20 of the vessel and pouring out the cooked pasta 30.

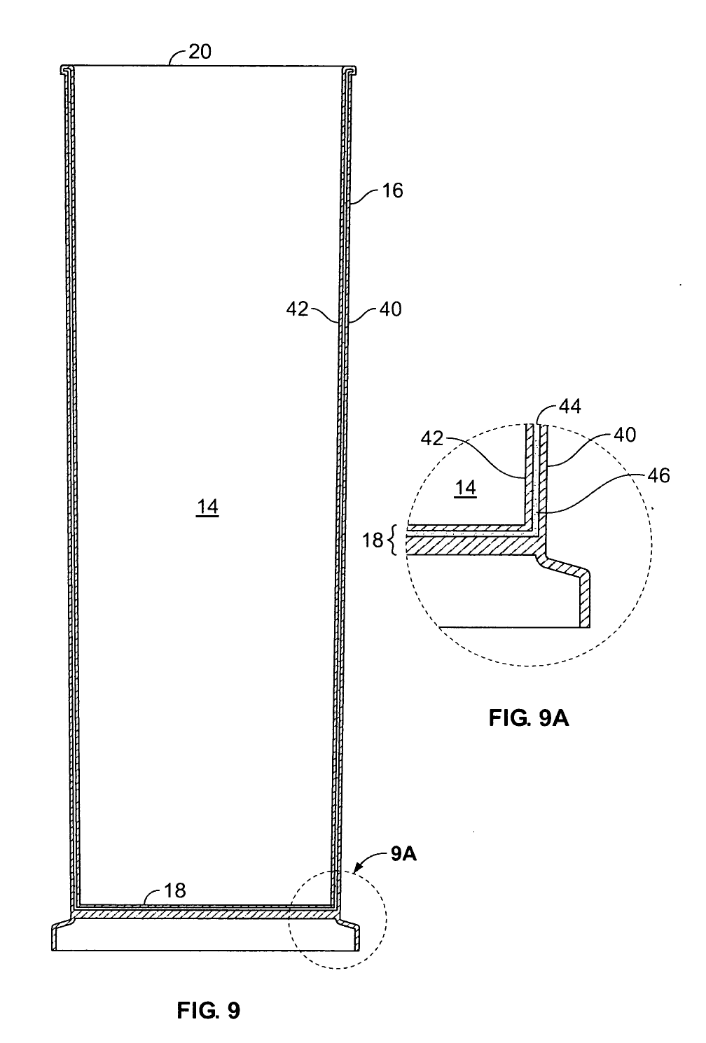

The efficacy of the vessel 12 is related to its ability to retain latent heat in the water 32. Accordingly, the preferred embodiment of the apparatus uses thermally insulated side walls 16 and a thermally insulated bottom 18 as shown in FIG. 9.

Turning to FIG. 9, the vessel 12 preferably uses interior and exterior plastic side walls 42 and 40, respectively, that are spatially separated from each other as shown in FIG. 9A to define a space 44 that reduces heat transfer from heated water 32 that is in the interior 14 of the vessel, i.e., just inside the interior wall 42. As is well known, thermal energy is not easily conducted across a vacuum. Therefore, in one preferred embodiment, the space 44 between the interior wall 42 and the exterior wall 40 is at least partially evacuated to leave air at a reduced (i.e., less than atmospheric) pressure. In another embodiment, the space 44 is filled with argon or other gas 46 that has a thermal conductivity less than air in order to retain as much heat as possible within the vessel 12.

As shown in FIGS. 1-9, the preferred embodiment of the apparatus for cooking by steeping is a thermally-insulated cylindrical or tube-shaped vessel 12, the top 20 of which is open but the bottom 18 of which is also thermally insulated. Those of ordinary skill in the mechanical arts will recognize that other shapes could be used instead of a tube or cylinder, including triangular or rectangular-shaped vessels, smaller in volume that traditional pots or other vessels in which pasta is cooked. A strainer and cover provided in the preferred embodiment described above would of course require corresponding shapes.

While the preferred embodiment uses plastics for each of the vessel 12, strainer 24 and cover 22, alternate embodiments of each of them may use metal or glass.

Using the preferred embodiment as described above, pasta and other foods can be safely and conveniently cooked using only the heat energy added to cooking water from another source and without using or requiring heat energy to be added to the water after its introduction into the vessel 12. Once the pasta is cooked by steeping, the vessel can be used as a server and easily disassembled for cleaning, storage and re-use.

While a preferred embodiment of the invention has been disclosed in detail, it should be understood by those skilled in the art that various modifications can be made to the illustrated embodiment without departing from the scope of the invention as described in the specification and hereafter defined in the appended claims.

What is claimed is:

1. An apparatus for cooking food items by steeping comprising:
a vessel having an interior volume defined by insulated side walls and an insulated bottom, said vessel having an open top through which water and a food item to be cooked can be introduced into the vessel interior and to which a cover or a strainer for said open top can be removably attached;
whereby food items introduced to hot water in said vessel cook without the introduction or additional of heat energy to said water.

2. The apparatus of claim 1, wherein said insulated side walls and insulated bottom retain heat energy in the water introduced into said vessel, such that heated water in said vessel cooks a food item without having to add heat energy thereafter.

3. The apparatus of claim 1, wherein said insulated side walls and said insulated bottom are formed of plastic.

4. The apparatus of claim 1 wherein said insulated side walls and said insulated bottom are formed of metal.

5. The apparatus of claim 1 wherein said insulated side walls are comprised of an exterior wall and an interior wall, said interior and exterior walls being separated from each other and defining therebetween, a predetermined space, said predetermined space reducing heat transfer into and from the vessel interior.

6. The apparatus of claim 5, wherein the predetermined space encloses a gas at a pressure that is less than atmospheric pressure.

7. The apparatus of claim 6, wherein the predetermined space encloses argon gas.

8. The apparatus of claim 1 wherein said insulated side walls are comprised of an exterior wall and an interior wall, said interior and exterior walls being separated from each other and of defining therebetween, a predetermined closed space, the closed space between said interior and exterior walls being at least partially fixed with a predetermined gas mixture having a heat conductivity less than air.

9. An apparatus for cooking food items by steeping comprising:
a vessel, having a non-pressurized interior volume defined by an insulated plastic side wall and an insulated plastic bottom and an open top through which water and food items can be introduced into the non-pressurized interior volume and to which a cover for the vessel or a strainer can be removably attached,
whereby said vessel cooks food items introduced into said vessel by steeping them in hot water introduced into to said vessel and without having additional heat energy added to said water.

10. The apparatus of claim 9 wherein said insulated side wall is comprised of an exterior wall and an interior wall, said interior and exterior walls being separated from each other and defining therebetween a predetermined closed space, a gas in said closed space being at a pressure less than atmospheric pressure.

11. The apparatus of claim 10 wherein said gas has a thermal conductivity less than air.

12. An apparatus for cooking a food item by steeping comprising:
a cylindrical, thermally-insulated tube having first and second ends;
an insulated, circular bottom attached to and closing said first open end of said tube thereby defining a thermally-insulated water-tight cylindrical vessel having an open end, through which water and food items can be introduced into the cylindrical vessel;
a strainer, removably affixed to said open end through which water can pass but which retains food items within said cylindrical vessel; and
a removable cover over said strainer;
whereby food items introduced into hot water in said cylindrical, thermally-insulated tube, cook using said hot water without having additional heat energy added to said water.

13. The apparatus of claim 12 wherein said thermally-insulated tube is comprised of an exterior tube and an interior tube, said interior and exterior tubes being separated from each other by a predetermined closed space, defining therebetween, a closed volume having a gas that is at a pressure less than atmospheric pressure.

14. An apparatus for passively cooking pasta comprising:
a plastic cylindrical, insulated tube having first and second ends;
an insulated, circular plastic bottom attached to and closing said first open end of said tube thereby forming a thermally-insulated water-tight cylindrical vessel having an open end, through which water and pasta can be put into the cylindrical vessel;
a strainer, removably affixed to said open end through which water can pass but which retains pasta within said cylindrical vessel; and
a removable cover over said strainer;
wherein said apparatus receives heated water and pasta through said open end and thereafter allows pasta to cook in said water using only the heat energy in the water that was added to said apparatus.

15. The apparatus of claim 11 wherein said thermally-insulated tube is comprised of an exterior tube and an interior tube, said interior and exterior tubes being separated from each other by a predetermined distance defining therebetween a closed space, the closed space between said interior and exterior tubes having a gas at a pressure less than atmospheric pressure.

16. The apparatus of claim 15 wherein said gas is a gas mixture having a thermal and/or radiant heat conductivity less than air.
